(19) United States
(12) Patent Application Publication
(10) Pub. No.: US 2006/0232071 A1
(43) Pub. Date: Oct. 19, 2006

(54) TURBO SET WITH STARTING DEVICE

(76) Inventor: Rolf Althaus, Herrliberg (CH)

Correspondence Address: CERMAK & KENEALY LLP, 515 E. BRADDOCK RD, SUITE B, ALEXANDRIA, VA, 22314, US

(21) Appl. No.: 11/279,923

(22) Filed: Apr. 17, 2006

(30) Foreign Application Priority Data
Apr. 18, 2005 (CH) 00689/05

(51) Int. Cl. H02P 9/04

(52) U.S. Cl. 290/40 R

(57) ABSTRACT

In a turbo set (100) with a starting device (120), the turbo set includes a compressor (102), a combustion chamber (103) and a turbine (104) and also a generator motor (108) which is drive-connected to the turbine (104). The starting device (120) serves for starting the turbo set and includes a steam generator (121) for the generation of steam which is under overpressure, a steam turbine (129) and an auxiliary generator (130). The steam generator (121) and the steam turbine (129) are connected to one another via a first supply line (125a) for the supply of steam generated in the steam generator (121) to the steam turbine (129). The auxiliary generator (130), on the one hand, is drive-connected to the steam turbine (129) and, on the other hand, for the transmission of electrical power from the auxiliary generator (130) to the generator motor (108), is electrically connected to the generator motor (108). In a method for starting the turbo set, the method includes generating steam which is under overpressure, at least partially expanding the steam so as to generate electrical power, and starting the turbo set electromotively with the electrical power.

This application claims priority under 35 U.S.C. § 119 to Swiss application number 00689/05, filed 18 April 2005, the entirety of which is incorporated by reference herein.

### BACKGROUND OF THE INVENTION

1. Field of the Invention

The invention relates to a turbo set with a starting device for starting the turbo set. The invention relates, furthermore, to a method for starting the turbo set.

2. Brief Description of the Related Art

The prior art discloses several methods and devices for starting turbo sets, such as, for example mobile or stationary gas or steam turbine plants or other turbo sets. Particularly in plants which are operated in a stationary manner for electricity generation, the starting of the turbo set demands stringent requirements from the starting device and the regulation of the starting operation on account of the high powers of the turbo set, along with the, as a rule, very high rotor masses.

To start a gas turbine plant, for example, an electric motor may be used, which, in order to start the plant, then has to be connected to the shaft of the compressor in order thereby to electromotively drive the compressor. The generator is often used as an electric motor for this purpose. The generator is connected via a shaft to the turbine of the gas turbine plant, and the turbine, in turn, is connected via this or a further shaft to the compressor. To start the plant, the generator is activated via a static frequency converter fed with electrical power from the network and thus functions as an electric motor.

In many instances, however, it is more cost-effective to start the gas turbine plant by means of compressed air injection. The compressed air required for this purpose originates from a reservoir which has previously been filled by means of an additional compressor or by a branch-off of compressed air when the plant has warmed up.

Such starting of the gas turbine plant by means of compressed air injection from an air accumulator is known, for example, from U.S. Pat. No. 4,033,114. In the gas turbine plant described here, the shafts of a high pressure turbine having a preceding high-pressure combustion chamber and of a low pressure turbine having a preceding low-pressure combustion chamber are connected to one another. Furthermore, the combustion air is supplied to the high-pressure combustion chamber from the air accumulator. The method for starting the gas turbine plant in this case comprises the following method steps: first, the gas turbine air has applied to it from the air accumulator until the operating rotational speed is reached. While the gas turbine is being run up, the high-pressure combustion chamber is ignited, the inlet temperature into the high-pressure part of the gas turbine being held at a minimum value. Subsequently, when the gas turbine is subjected to load, the low-pressure combustion chamber is ignited, and the pressure upstream of the high-pressure turbine is increased up to the full operating pressure. In this case, the air quantity flowing through the high-pressure and low-pressure turbine is higher than during continuous operation. Thereafter, the inlet temperature upstream of the low-pressure part of the gas turbine is increased until the full power of the gas turbine is reached, the inlet temperature upstream of the high-pressure part of the gas turbine subsequently being increased linearly from the minimum value to the full operating temperature. Simultaneously with the increase in the inlet temperature into the high-pressure part, the inlet temperature into the low-pressure part is increased in such a way that the power of the gas turbine remains constant and the air throughput is reduced to the normal value.

U.S. Pat. No. 3,704,586, too, discloses a starting circuit for a gas turbine plant. The gas turbine plant, here, comprises a coal pressure gasifier, an expansion turbine with a high-pressure compressor and with an assigned motor generator, a boiler with a connected gas turbine and with a low-pressure compressor coupled to it and a starting motor. The pressure gasifier is assigned a starting compressed air accumulator, the starting compressed air accumulator being connected to the high-pressure compressor and being charged by means of a part stream of the generated compressed air. The starting compressed air accumulator is in this case dimensioned such that the compressed air stored in it is sufficient in order, during the starting of the plant, to start a minimum number of pressure gasifier assemblies by means of compressed air from the compressed air accumulator. As a result, the turbine, additionally driven motively by the motor generator, and the gas turbine, initially driven by the starting motor, can be brought to power to an extent such that the overall plant ultimately can be operated independently at first during idling.

The solution of starting a gas turbine plant by means of compressed air injection has the disadvantage, however, that a relatively large reservoir has to be made available so that sufficient compressed air can be stored. Particularly in the case of large stationary gas turbine plants, this can be implemented only via very large accumulator volumes which entail a relatively high cost in terms of construction. Also, after an operation to start the plant, the reservoir first has to be filled up again before a new starting operation can be carried out. If, for example, an operation to start the plant is discontinued at a first attempt, then a second starting attempt normally cannot be carried out immediately thereafter. Particularly with regard to this situation where starting is discontinued, the plant also has to be equipped additionally with a further compressor so that the reservoir can be filled again with the aid of the compressor.

### SUMMARY OF THE INVENTION

The invention is intended to remedy this. One aspect of the present invention includes, therefore, specifying a turbo set with a starting device of the aforementioned type, by means of which the disadvantages of the prior art are reduced or avoided. Furthermore, another aspect of the present invention includes a method for starting such a turbo set.

The invention contributes, in particular, to making available a starting device which, while having a high drive power, nevertheless also has an only relatively low space requirement. Moreover, the turbo set is to be capable of being started with the aid of the starting device without a tie-up to an external power supply.

Another aspect of the present invention includes that the turbo set comprises a compressor, a combustion chamber, a turbine, and a generator motor. The compressor, combustion chamber, and turbine are arranged along a flow path of the flow of the turbo set. The generator motor is drive-connected to the turbine. For the purpose of starting the turbo set, furthermore, a starting device is assigned to the turbo set. The starting device comprises a steam generator for the generation of steam which is under overpressure, a steam turbine, and an auxiliary generator. The steam generator and the steam turbine are connected to one another via a first supply line. Steam generated in the steam generator is supplied to the steam turbine via the first supply line. The auxiliary generator, on the one hand, is drive-connected to the steam turbine and, on the other hand, for the transmission of electrical power from the auxiliary generator to the generator motor, is electrically connected to the generator motor.

To start the turbo set, steam which is under overpressure is generated in the steam generator and is then supplied to the steam turbine via the first supply line. In the steam turbine, the steam then expands at least partially, thereby driving the steam turbine which, in turn, drives the auxiliary generator. The driven auxiliary generator generates electrical power which is transmitted to the generator motor via the electrical connection. During the operation to start the turbo set, the generator motor is operated as an electric motor. Consequently, the turbine is driven by the generator motor by means of the electrical power delivered by the auxiliary generator.

The turbo set is thus started by means of the generator motor in a similar way to that known from the prior art. In comparison with the solutions known from the prior art, however, the generator motor does not require any energy supply from an external electricity network. The turbo set with starting device according to the invention can be started self-sufficiently. This is a decisive advantage particularly for plants which are operated remotely from an external electricity supply.

The steam required for the starting operation is generated in the steam generator at the time of starting or immediately before this. In comparison with the utilization of compressed air, for example, for the injection of compressed air upstream of the turbine, the utilization of steam affords the advantage that there is no need for the steam to be supplied to be stored in an aggregated gaseous state. Before evaporation, the steam is in the aggregated liquid state and thus requires only a very low accumulator volume. Furthermore, by means of one or even more steam generators, steam can be generated at the time of the starting the turbo set in a quantity which is sufficient for making it possible to start even large turbo sets operated in a stationary manner, for example gas or steam turbine plants or even combined-cycle plants operated in a stationary manner for electricity generation. Furthermore, it is possible, without major structural requirements, to design the accumulator volumes for storing the initial fluid, which is to be stored in an aggregated liquid state and is required for steam generation, so as to be even sufficiently large to allow a multiple repetition of the starting operation at short time intervals with respect to one another.

A significant advantage of the solution according to the invention is that even old plants can be retrofitted in a simple way, without a high outlay in terms of apparatus, with a starting device designed according to the invention.

The sequence of the operation to start the turbo set then corresponds, further, to the operations to start turbo sets which are known from the prior art. Consequently, the turbo set is normally run up to a minimum rotational speed at which the combustion chamber can be ignited and from which the turbo set can then be run up further by its own power.

So that the turbo set can be started, decoupled in terms of rotational speed, independently of the rotational speed of the auxiliary generator which is current in each case, the electrical connection advantageously additionally comprises a static frequency converter as well as an electricity line. The static frequency converter allows controlled frequency conversion of the electrical power generated by the auxiliary generator, before the electrical power is supplied to the generator motor.

In a preferred embodiment of the invention, the steam generator comprises a hydrogen accumulator and an oxygen accumulator and also a burner for the combustion of hydrogen from the hydrogen accumulator with oxygen from the oxygen accumulator. For this purpose, the hydrogen and oxygen are combined in the burner. A hydrogen reaction then gives rise in the burner to steam from the hydrogen and the oxygen. During the hydrogen reaction, therefore, no further combustion byproduct is produced. Also, in particular, there is no need for any further fossil fuel, such as, for example diesel or electrical energy, for steam generation.

In addition to a low space requirement, a steam generator designed in this way is also considerably less maintenance-intensive than a conventional diesel assembly or a conventional auxiliary gas turbine. This leads ultimately to lower maintenance costs, a higher degree of reliability of the steam generator and, overall, also to a higher degree of availability.

Furthermore, combustion of hydrogen and oxygen in a hydrogen reaction affords the advantage that the pressure level at which the combustion reaction takes place and therefore also the outlet pressure of the generated steam can easily be regulated. Thus, it is possible in a simple way, and, in particular, without necessitating a compressor, to ensure that the generated steam has a sufficient overpressure to provide a pressure drop from the steam generator as far as the outlet from the steam turbine which is sufficient for the flow of steam.

Preferably, the starting device additionally comprises a water-injection device for the regulated injection of additional water into the supply line. The water injection device may comprise, for example, a multiplicity of individual nozzles which issue into the first supply line. The additionally injected water serves, on the one hand, for cooling the steam supplied to the steam turbine. After combustion in the steam generator, the steam initially has a relatively high temperature of, as a rule, about 1200 K-1300 K. For inlet into the steam turbine, a temperature of about 500 K-600 K is usually sufficient. In addition to the cooling of the steam, further steam is also generated as a result of the injection of additional water.

According to an advantageous development of the invention, the starting device comprises, furthermore, a second supply line for the supply of steam emerging from the steam turbine into the flow path of the turbo set. For this purpose, a first end of the second supply line is connected to the outlet from the steam turbine. A second end of the second supply line issues, downstream of the compressor, into the flow path of the turbo set. The partially expanded steam emerging from the steam turbine is consequently fed into the flow path of the turbo set via the second supply line. In the case of an open working process of the turbo set, the fed-in steam expands in the turbine to ambient pressure. In the case of a closed working process of the turbo set, the steam expands in the turbine to the lower process pressure. As a result of the expansion of the fed-in steam which takes effect in the turbine of the turbo set, the turbine is additionally driven, the starting operation thereby taking place in a shorter period of time.

In an expedient refinement of the invention, the second supply line issues into the flow path of the turbo set between the outlet from the compressor and the inlet into the combustion chamber. Thus, after entering the flow path, the supplied steam flows first through the combustion chamber and thereafter through the turbine. This leads to an increase in the mass throughput through the combustion chamber, with the result that the combustion chamber can be ignited earlier.

Alternatively or additionally, however, the second supply line may also expediently issue into the combustion chamber. The second supply line may also issue into the flow path between the outlet from the combustion chamber and the inlet into the turbine.

In an at least two-stage turbine with at least one first turbine stage and one second turbine stage, it may also be expedient, alternatively or additionally, to cause the second supply line also to issue into the flow path between the first and the second turbine stage. The supplied steam then expands via the turbine stage arranged downstream of the issue or via the turbine stages arranged downstream of the issue.

In the case of a second turbine arranged downstream of the first turbine, it may also be expedient to cause the second supply line to issue into the flow path between the two turbines.

Expediently, the first supply line and/or the second supply line are/is designed to be closable. At the commencement of the starting operation, the supply lines are closed. A sufficient pressure buildup can therefore initially take place in the steam generator, before the respective supply line or else both supply lines is or are opened at a defined time point and the starting operation is started per se. Likewise, at the termination of the starting operation, too, the respective supply line or else both supply lines can be closed at a defined time point.

In a further aspect, the invention makes available a method for starting a turbo set. The turbo set of the method according to the invention comprises a compressor, a combustion chamber, and a turbine, the compressor, combustion chamber, and turbine being arranged along a flow path. The method according to the invention comprises the method steps of generating steam which is under overpressure, of at least partially expanding the steam so as to generate electrical power, and of starting the turbo set electromotively by means of the electrical power.

The advantages of the method according to the invention, as compared with the methods known from the prior art, correspond to the statements made above with regard to the turbo set designed according to the invention, with a starting device.

The sequence of the operation to start the turbo set then corresponds, further, to the operations to start turbo sets which are known from the prior art. Consequently, the turbo set is normally run up to a minimum rotational speed, from which the turbo set can be run up further by its own power.

According to a further refinement of the method according to the invention, the steam is generated as a result of the combustion of hydrogen with oxygen. For this purpose, hydrogen and oxygen are delivered for combustion separately from one another and react with one another in a hydrogen reaction in order to form steam. It is a significant advantage that no further combustion byproducts are produced during the hydrogen reaction. In particular, there is no need for any further fossil fuel for the generation of steam.

Furthermore, the combustion of hydrogen and oxygen in a hydrogen reaction affords the advantage that the pressure level at which the combustion reaction takes place and therefore also the outlet pressure of the generated steam can easily be regulated. Thus, it is possible in a simple way, and in particular without the need to provide a compressor for this purpose, to ensure that the generated steam has a sufficient overpressure in order to provide a pressure drop from the steam generator as far as the outlet from the steam turbine which is sufficient for the steam flow.

Expediently, water is additionally supplied to the generated steam before expansion. The supply of water serves, on the one hand, for cooling the generated steam and, on the other hand, for increasing the generated steam quantity.

According to an advantageous development of the method, after partial expansion, the steam is supplied into the flow path of the turbo set. In the case of an open working process of the turbo set, the steam can be expanded to ambient pressure after being fed into the flow path of the turbo set. In the case of a closed working process of the turbo set, the steam can be expanded to the lower process pressure after being fed in. As a result of the expansion of the steam which takes effect in the turbine of the turbo set, the turbine is additionally driven and the starting operation is thereby accelerated.

Expediently, the steam is supplied to the flow path between the compressor outlet and combustion chamber inlet and/or in the combustion chamber and/or between the combustion chamber outlet and turbine inlet and/or, in a turbine of at least two-stage design, between the turbine stages.

The method according to the invention is suitable for starting any turbo sets, in particular for starting gas or steam turbine plants or even combined-cycle plants.

### BRIEF DESCRIPTION OF THE DRAWINGS

The invention is explained in more detail below by means of an exemplary embodiment illustrated in the figures, in which:

FIG. 1 shows a turbo set known from the prior art, with compressed air injection;

FIG. 2 shows a turbo set with starting device according to the invention.

Only the elements and components essential for understanding the invention are illustrated in the figures.

The exemplary embodiment illustrated is to be understood purely instructively and is to serve for a better understanding of the subject ofthe invention, but not for restricting this.

### DETAILED DESCRIPTION OF EXEMPLARY EMBODIMENTS

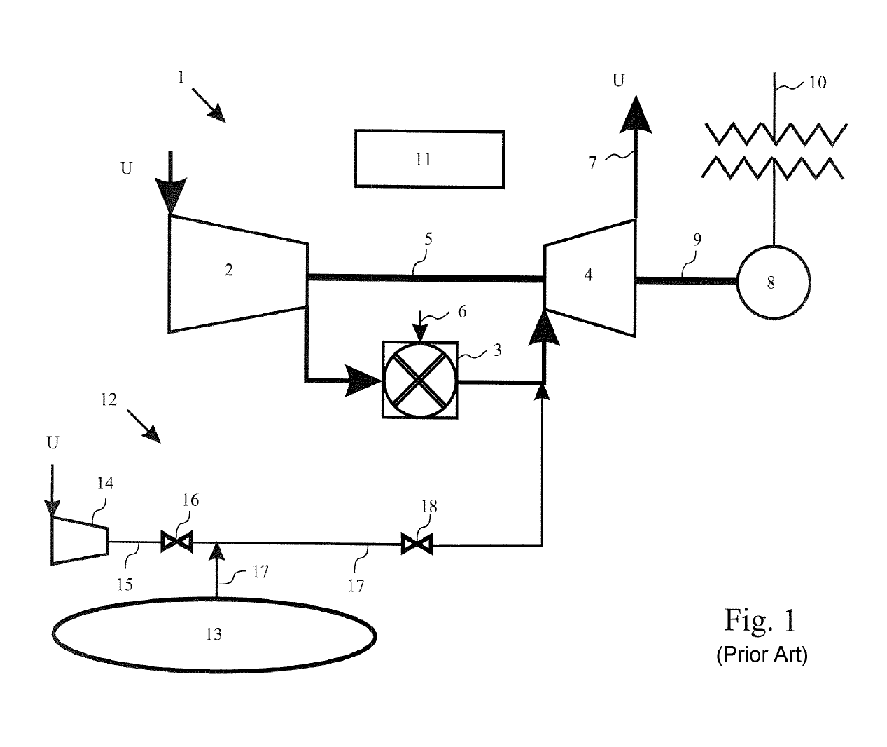

FIG. 1 shows a diagrammatic illustration of a gas turbine plant 1, such as is familiar to a person skilled in the art. The gas turbine plant 1, designed here as a stationary plant, serves for the generation of electricity. However, in principle, the invention may also be applied to mobile plants or turbo sets used in another way.

The gas turbine plant 1 includes a compressor 2 which sucks in air from the surroundings U on the inlet side and compresses it. The compressor 2 is drive-connected fixedly in terms of rotation to a turbine 4 via a shaft 5. In the gas path between the compressor 2 and the turbine 4, a combustion chamber 3 is arranged, which is fed with fuel for firing via the fuel feed line 6. After passing through the turbine 4, the air/fuel gas mixture flows out into the surroundings U again via an exhaust gas line 7. The turbine 4 is drive-connected to a generator 8 via a further shaft 9. The shafts 5 and 9 may also be of one-part design. During operation, the gas turbine plant 1 illustrated here delivers a power of about 220 MW which is converted into electricity via the generator 8 driven by the turbine 4 and is discharged into an electrical network 10 via an electricity line and a transformer. The gas turbine plant 1 includes, furthermore, an electricity supply assembly 11, by means of which the gas turbine plant 1 is supplied with electricity especially during the warm-up phase.

The gas turbine plant 1 may, of course, also be of multishaft design, with a plurality of turbines and intermediately arranged combustion chambers, with a plurality of compressors and intermediately arranged coolers, and the like. These further embodiments are familiar to a person skilled in the art and place the invention merely in a context which is familiar to a person skilled in the art, and therefore this is not discussed further at this juncture.

So that the gas turbine plant 1 can be started, the gas turbine plant 1 illustrated in FIG. 1 includes, furthermore, a compressed air injection device 12 as a starting device for starting the gas turbine plant. The compressed air injection device 12 includes a reservoir 13 which is filled with compressed air by a compressor 14 via the filling line 15. The filling line 15 can be closed by means of a throttle slide 16 integrated into the filling line. The compressed air injection device 12 includes, furthermore, a connecting line 17 which can likewise be closed by means of a throttle slide 18 integrated into the connecting line 17. One end of the connecting line 17 is connected to the reservoir 13. The other end of the connecting line 17 issues into the flow path of the gas turbine plant 1 between the combustion chamber 3 and the turbine 4. To start the gas turbine plant 1, the throttle slide 18 is opened, so that compressed air flows out of the reservoir 13 via the connecting line 17 into the turbine 4. The compressed air introduced into the gas turbine plant via the connecting line 17 then expands across the turbine 4, with the result that the turbine 4 is set in rotation. The compressor 2 is driven via the shaft 5, and thereby sucks in air from the surroundings U and compresses it. Beyond a certain compressor rotational speed, the mass air flow delivered to the combustion chamber 3 from the compressor 2, is sufficient to make it possible to ignite the combustion chamber 3. In the example illustrated here, this minimum rotational speed of the compressor lies at a power output of about 15 MW for the gas turbine plant 1. After the ignition of the combustion chamber 3, this is normally followed by a stabilization phase, before the injection of compressed air into the gas turbine plant is terminated. The rotational speed of the plant can then, as required, be increased further independently by means of an increase in the supplied fuel quantity.

Since the compressed air required for starting the gas turbine plant 1 cannot be generated in sufficient quantity at the time of the starting operation, the compressed air must be made available in the reservoir 13 even before the starting of the injection operation. This normally takes place by means of the compressor 14 or by a branch-off of compressed air from the gas turbine plant 1 itself Such a branch-off of compressed air can, of course, be carried out only during the operation of the plant, that is to say during the operation of the plant in each case only for a later starting operation.

By contrast, the arrangement of an additional compressor 14 for filling the reservoir 13 entails high costs in terms of the procurement and operation of the compressor 14. Such a compressor is also without a function during a predominant part of the operating period of the gas turbine plant 1. By contrast, if the reservoir 13 is filled during the operation of the gas turbine plant by compressed air being branched off, then at least a first filling of the reservoir 13 has to take place with the aid of an additional compressor. Also, for example after a discontinued operation to start the gas turbine plant 1, it may be necessary to fill the reservoir up again, since the compressed air quantity which has remained in the reservoir is no longer sufficient for a second starting operation. As in the very first starting operation, too, in these cases, a filling of the reservoir by means of an additional compressor is required.

A further very serious disadvantage is the relatively large structural volume for the reservoir 13. Since a sufficient compressed air quantity has to be stored in the reservoir in order to run up the gas turbine to about one-tenth of the power of the gas turbine as a design point, the reservoirs normally having large volumes of several hundred cubic meters must be provided. In a plant described in U.S. Pat. No. 3,704,586, the reservoir, designated by 12, includes 400 cubic meters at an operating pressure of 36 bar. Such large pressure-resistant volumes require structurally complicated measures and thereby increase the costs of such a plant. The construction space required for the reservoir also cannot be utilized in any other way.

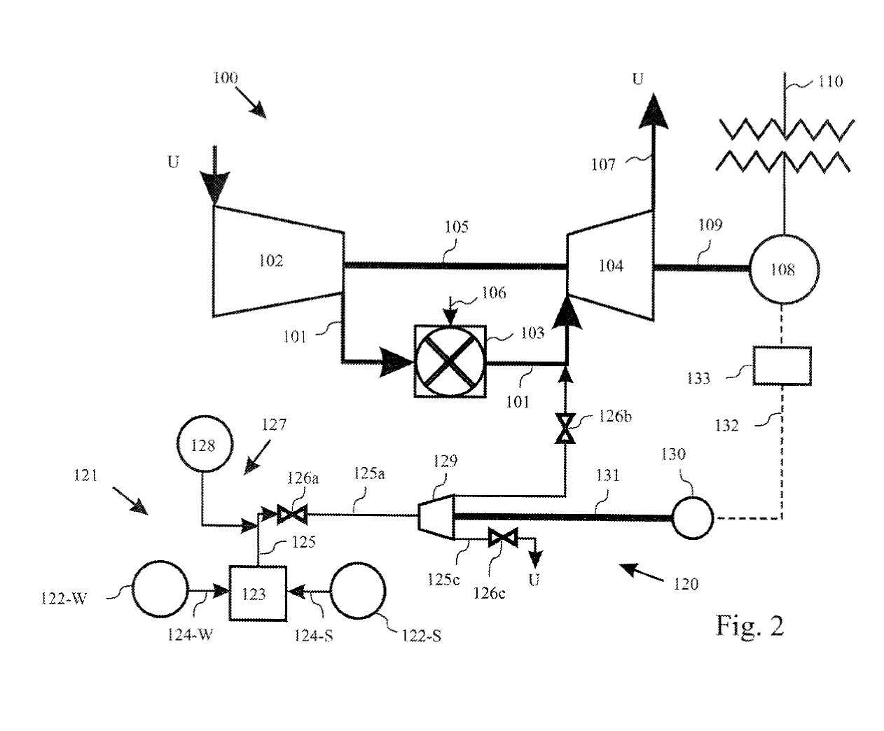

This is where invention comes in. FIG. 2 shows a turbo set 100 according to the invention with starting device 120. The turbo set illustrated may, for example, be part of an energy-generation plant, such as, for example, a gas turbine plant or a combined gas and steam power plant.

The turbo set 100 illustrated in FIG. 2 includes a multistage compressor 102, a combustion chamber 103 with fuel feed line 106 and a two-stage turbine 103 together with exhaust gas line 107. The compressor 102, combustion chamber 103 and turbine 104 are arranged along the flow path 101 of the turbo set. Furthermore, the compressor 102 and the turbine 104 are drive-connected to one another via a shaft 105. The turbo set includes, furthermore, a generator motor 108 which is drive-connected to the turbine 104 via a shaft 109. During the operation of a turbo set 100, the generator motor 108 generates electricity which is fed into an external network 1 10. However, the generator motor 108 may also be operated as an electric motor.

To start the turbo set 100, a starting device 120 is assigned to the turbo set. The starting device 120 includes a steam generator 121 for the generation of steam which is under overpressure, a steam turbine 129 and an auxiliary generator 130. The steam generator 121 and steam turbine 129 are connected to one another via a first supply line 125a for the supply of steam generated in the steam generator 121 to the steam turbine 129. A second supply line 125b additionally leads away from the steam turbine 129 and issues into the flow path 101 of the turbo set 100. Partially expanded steam emerging from the steam turbine 129 can thus be fed into the flow path 101 of the turbo set by means of the second supply line 125b. For this purpose, in the exemplary embodiment illustrated in FIG. 2, the second supply line 125b issues into the flow path 101 between the outlet from the combustion chamber 103 and the inlet into the turbine 104. Alternatively, however, the steam may also be discharged into the surroundings U via the discharge line 125c. The latter possibility is expedient particularly when the overall pressure drop of the steam has already been reduced in the steam turbine.

Throttle slides 126a, 126b and 126c are integrated here into the first supply line 125a, into the second supply line 125b and into the third supply line 125c, respectively, and are preferably activated by a central regulating device (not illustrated in FIG. 2). While the throttle slides 126a and 126b are completely closed when the turbo set is at a standstill, and also when the turbo set is run up, the throttle slides 126a and 126b are opened for starting the turbo set 100, in order thereby to allow the steam generated in the steam generator 121 to flow via the supply line 125a into the steam turbine and from there via the supply line 125b into the flow path 101 of the turbo set 100.

The auxiliary generator 130 is drive-connected to the steam turbine 129 via a shaft 131. Furthermore, the auxiliary generator 130 is connected to the generator motor 108 via an electrical line 132. A static frequency converter 133 is additionally interposed here, into the electrical line 132. During operation the auxiliary generator 130 is driven by the steam turbine 129 and thereby generates electrical power. The maximum power output of the auxiliary generator 130 illustrated here amounts to 15 MW in the case of a maximum power for the turbo set of 220 MW. The electrical power generated in the auxiliary generator 130 is transmitted to the generator motor 108 from the auxiliary generator 130 by means of the electrical line 132. The static frequency converter 133 ensures frequency matching in the process. The generator motor 108, operated as an electric motor during the operation to start the turbo set, converts the electrical power generated by the auxiliary generator 130 into mechanical rotations again which is transmitted via the shaft 109 to the turbine 104 and from there via the shaft 105 also to the compressor 102.

The steam generator 121 illustrated in FIG. 2 includes a hydrogen accumulator 122-W and an oxygen accumulator 122-S and also a burner 123 for the combustion of hydrogen from the hydrogen accumulator 122-W with oxygen from the oxygen accumulator 122-S. For this purpose, the burner 123 is connected to the accumulators 122-W and 122-S via the feed lines 124-W and 124-S. The hydrogen accumulator 122-W and the oxygen accumulator 122-S are designed as liquid gas accumulators. The hydrogen and oxygen are thus present in the accumulators in liquid form and under high pressure. Since the hydrogen and the oxygen are stored in liquid form, a considerably smaller accumulator volume is required for storing a specific molar quantity of hydrogen and oxygen than would be necessary if the same molar quantity of compressed air or even of gaseous steam were to be stored. Moreover, water has a high expansion rate during evaporation.

To start the turbo set 100, hydrogen and oxygen are extracted, as required, from the accumulators 122-W and 122-S, are introduced into the burner 123 and are burnt there in a hydrogen reaction to form steam. The regulation of the introduction of hydrogen and oxygen into the burner takes place by means of throttling and regulating elements, which are not illustrated in FIG. 2, but are familiar to a person skilled in the art.

The hydrogen reaction takes place highly exothermally, so that the steam emerging from the burner 123 has a very high temperature of about 1200 K-1300 K. In order, on the one hand, to cool the temperature of the steam to a lower temperature of about 500 K-700 K and, on the other hand, additionally to increase the quantity of steam provided, the starting device 120 includes, furthermore, a water injection device 127 for the regulated injection of additional water from a water reservoir 128 into the supply line 125. By means of the water injection device 127, a regulated quantity of demineralized water is admixed to the steam coming from the burner 123 and at the same time evaporates. The regulating device used in quantity regulation and the throttle slides required for regulating the water quantity supplied are not illustrated in FIG. 2. These, however, are familiar to a person skilled in the art.

After the admixing of additional water, the steam located in the supply line 125 has a temperature of about 500 K-700 K.

Thus, to start the turbo set 100, first, hydrogen which is under overpressure and oxygen which is under overpressure are extracted from the accumulators 122-W and 122-S and are introduced into the burner 123 where the hydrogen burns with the oxygen to form steam. Additional water from the reservoir 128 is admixed in the supply line 125a to the steam coming from the burner 123, and the steam quantity is thereby increased. The steam thus generated, which is under an overpressure of about 10 bar, is delivered via the supply line 125a to the steam turbine 129 and is partially expanded here to an outlet pressure of about 5 bar. As a result of the partial expansion of the steam, the steam turbine 129 is driven and, in turn, via the shaft 131, drives the auxiliary generator 130. The latter thereby generates electrical power which is transmitted from the auxiliary generator 130 to the generator motor 108 by means of the electrical line 132. In the starting state, the generator motor 108 operates as an electric motor. By means of the static frequency converter 133 interposed into the line 132, the electrical power is frequency-matched, so that the rotational frequency of the generator motor 108 is independent of the rotational frequency of the auxiliary generator 130. The electrical power generated by the auxiliary generator 130 and supplied to the generator motor 108 is thus converted into mechanical rotation again by the generator motor 108, and this mechanical rotation is transmitted via the shaft 109 to the turbine 104 and from there via the shaft 105 also to the compressor 102.

Furthermore, the partially expanded steam, after emerging from the steam turbine 129, is fed into the flow path 101 of the turbo set 100 via the supply line 125b. The steam quantity fed into the flow path 101 expands across the turbine 104, with the result that the turbine 104 is additionally also driven directly.

The turbo set 100 illustrated in FIG. 2 and the method described for starting the turbo set 100 constitute merely exemplary embodiments of the invention which may perfectly well be modified in many different ways by a person skilled in the art, without departing from the idea of the invention. Thus, for example, a combination of the starting device according to the invention or of the starting method according to the invention with other starting devices and starting methods known from the prior art is possible.

List of Reference Symbols

U Surroundings

1 Gas turbine plant

2 Compressor

3 Combustion chamber

4 Turbine

5 Shaft between compressor and turbine

6 Fuel feed line

7 Exhaust gas line

8 Generator

9 Shaft between turbine and generator

10 Network

11 Electricity supply assembly

12 Compressed air injection device

13 Reservoir

14 Compressor

15 Filling line

16 Throttle slide

17 Connecting line

18 Throttle slide

100 Turbo set designed according to the invention, with starting device

101 Flow path ofthe turbo set

102 Compressor

103 Combustion chamber

104 Turbine

105 Shaft between compressor and turbine

106 Fuel feed line

107 Exhaust gas line

108 Generator motor

109 Shaft between turbine and generator

110 Network

120 Starting device

121 Steam generator

122-W Hydrogen accumulator

122-S Oxygen accumulator

123 Burner

124-W, 124-S Feed lines

125a, 125b Supply lines

125c Discharge line

126a, 126b, 126c Throttle slides

127 Water-injection device

128 Water reservoir

129 Steam turbine

130 Auxiliary generator

131 Shaft

132 Electrical line

133 Static frequency converter

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A turbo set comprising:
a compressor;
a combustion chamber;
a turbine; and
a generator motor;
wherein the compressor, the combustion chamber, and the turbine are arranged along a flow path, and the generator motor is drive-connected to the turbine
a starting device configured and arranged to start the turbo set, the starting device comprising a steam generator configured and arranged to generate overpressurized steam, a steam turbine, a first supply line, and an auxiliary generator, the steam generator and the steam turbine being connected to one another via the first supply line for the supply of steam generated in the steam generator to the steam turbine, the auxiliary generator being drive-connected to the steam turbine and electrically connected to the generator motor for the transmission of electrical power from the auxiliary generator to the generator motor.

2. The turbo set as claimed in claim 1, wherein the steam generator comprises a hydrogen accumulator, an oxygen accumulator, and a burner configured and arranged to combust hydrogen from the hydrogen accumulator with oxygen from the oxygen accumulator.

3. The turbo set as claimed in claim 1, wherein the starting device further comprises a water-injection device configured and arranged to regulatedly inject additional water into the first supply line.

4. The turbo set as claimed in claim 1, further comprising:
an electrical line forming the electrical connection between the auxiliary generator and the generator motor.

5. The turbo set as claimed in claim 1, wherein the starting device further comprises a second supply line configured and arranged to supply steam emerging from the steam turbine into the flow path of the turbo set, including a first end of the second supply line connected to the steam turbine, and a second end of the second supply line issuing into the flow path of the turbo set downstream ofthe compressor.

6. The turbo set as claimed in claim 5, wherein the first supply line, the second supply line, or both supply lines, is closable.

7. A method for starting a turbo set having a compressor, a combustion chamber, and a turbine, the compressor, combustion chamber, and turbine being arranged along a flow path, the method comprising:
generating overpressurized steam;
at least partially expanding the steam to generate electrical power; and
starting the turbo set electromotively with the electrical power.

8. The method as claimed in claim 7, wherein generating steam comprises combusting hydrogen with oxygen.

9. The method as claimed in claim 7, further comprising:
supplying additional water to the steam before expansion.

10. The method as claimed in claim 7, further comprising:
supplying the at least partially expanded steam into the flow path of the turbo set.

11. The turbo set as claimed in claim 4, wherein the electrical line comprises a static frequency converter.
